(19) United States
(12) Patent Application Publication
(10) Pub. No.: US 2024/0378497 A1
(43) Pub. Date: Nov. 14, 2024

(54) METHOD AND APPARATUS FOR OPERATING MULTI-TASK LEARNING MODEL

(71) Applicant: Korea University of Technology and Education Industry-University Cooperation Foundation, Cheonan-si (KR)

(72) Inventors: Won Tae KIM, Cheonan-si (KR); Young Jin KIM, Cheongju-si (KR); Han Jin KIM, Cheongju-si (KR)

(21) Appl. No.: 18/447,675

(22) Filed: Aug. 10, 2023

(30) Foreign Application Priority Data
May 10, 2023 (KR) 10-2023-0060728

(51) Int. Cl. G06N 20/00

(52) U.S. Cl. CPC G06N 20/00

(57) ABSTRACT

The operation method of a multi-task learning model according to an embodiment of the present disclosure may include: obtaining a common feature vector of a previous step; receiving input data corresponding to a current task executed in a current step from among a plurality of tasks; extracting a common feature vector of the current step based on the common feature vector of the previous step and the input data corresponding to the current task; extracting an output feature vector corresponding to the current task based on the common feature vector of the current step; and outputting output data corresponding to the current task based on the output feature vector corresponding to the current task.

### CROSS-REFERENCE TO RELATED APPLICATION

This application claims the priority of the Korean Patent Applications NO 10-2023-0060728, filed on May 10, 2023, in the Korean Intellectual Property Office. The entire disclosures of all these applications are hereby incorporated by reference.

### BACKGROUND

### 1. Field

One or more embodiments relate to an asynchronous multi-task learning framework, and more particularly, to an asynchronous multi-task learning framework for supporting multi-task learning under asynchronous tasks and asynchronous input data.

### 2. Description of the Related Art

Deep learning is defined as a set of machine learning algorithms that attempt a high level of abstraction (e.g., the task of summarizing key contents or functions in a large amount of data or complex data) through a combination of several nonlinear transformation techniques, and it can be seen as a field of machine learning that teaches computers how to think in a large frame.

Many studies (e.g., research on how to make better representation techniques and how to build models to learn them) have been conducted to represent data in a form that a computer can understand (e.g., in the case of an image, pixel information is expressed as a column vector, etc.) and apply it to learning, and as a result of these efforts, various deep learning techniques such as deep neural networks, convolutional deep neural networks, and deep belief networks have been applied to fields such as computer vision, speech recognition, natural language processing, and voice/signal processing to show cutting-edge results.

Multi-task learning is a subfield of machine learning that exploits similarities and differences while simultaneously solving multiple learning tasks. When a multi-task learning model is applied, the learning efficiency and prediction accuracy of the model may be improved for each task rather than when the model is trained individually.

Existing multi-task learning methods are mainly synchronous multi-task learning methods that assume that each task and input data required by the tasks are synchronized over time. However, because most tasks in reality are executed asynchronously with each other over time, the performance of a synchronous multi-task learning method may deteriorate due to data loss at some point in time.

### DESCRIPTION OF EMBODIMENTS

### Technical Solution

As an embodiment of the present disclosure, an operation method of a multi-task learning model may be provided.

The operation method of a multi-task learning model according to an embodiment of the present disclosure may include: obtaining a common feature vector of a previous step; receiving input data corresponding to a current task executed in a current step from among a plurality of tasks; extracting a common feature vector of the current step based on the common feature vector of the previous step and the input data corresponding to the current task; extracting an output feature vector corresponding to the current task based on the common feature vector of the current step; and outputting output data corresponding to the current task based on the output feature vector corresponding to the current task.

The extracting of the common feature vector of the current step according to an embodiment of the present disclosure may include: extracting a first feature vector based on the common feature vector of the previous step; extracting a second feature vector based on the input data corresponding to the current task; and extracting the common feature vector of the current step based on the first feature vector and the second feature vector.

The extracting of the first feature vector according to an embodiment of the present disclosure may include: extracting the first feature vector including common feature information over time by inputting the common feature vector of the previous step to a first model, and the extracting of the second feature vector comprises: inputting the input data corresponding to the current task to a second model and extracting the second feature vector including common feature information of the input data corresponding to the current task.

The extracting of the common feature vector of the current step according to an embodiment of the present disclosure may include: determining a weight between the first feature vector and the second feature vector; and extracting the common feature vector through an inner product calculation between the common feature vector of the previous step and the first feature vector and the second feature vector, based on the determined weight.

The number and type of input data corresponding to the current task according to an embodiment of the present disclosure may vary for each step.

### BRIEF DESCRIPTION OF THE DRAWINGS

FIGS. 1A and 1B are views for explaining multi-task learning according to an embodiment.

FIG. 2A is a view for explaining synchronous multi-task running.

FIG. 2B is a view for explaining asynchronous multi-task running according to an embodiment.

FIG. 3 is a view of a structure of a multi-task learning model according to an embodiment.

FIG. 4 is a view illustrating an example of an operation method of a multi-task learning model according to an embodiment.

FIG. 5 is a view for explaining an operation method of a multi-task learning model according to an embodiment.

### DETAILED DESCRIPTION

Hereinafter, embodiments of the present invention will be described with reference to the drawings. In the following description, descriptions of a well-known technical configuration in relation to a lead implantation system for a deep brain stimulator will be omitted. For example, descriptions of the configuration/structure/method of a device or system commonly used in deep brain stimulation, such as the structure of an implantable pulse generator, a connection structure/method of the implantable pulse generator and a lead, and a process for transmitting and receiving electrical signals measured through the lead with an external device, will be omitted. Even if these descriptions are omitted, one of ordinary skill in the art will be able to easily understand the characteristic configuration of the present invention through the following description.

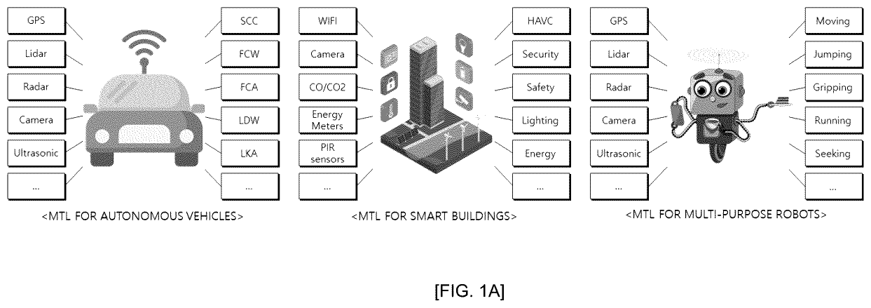

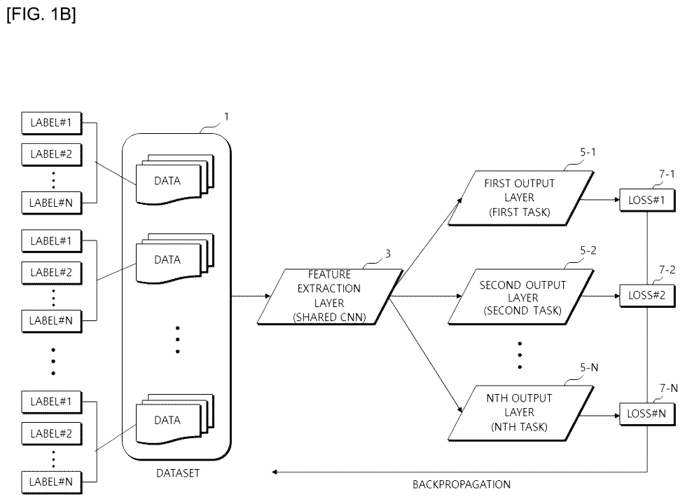

FIGS. 1A and 1B are views for explaining multi-task learning according to an embodiment.

In this specification, a task refers to a task to be solved through machine learning or a task to be executed through machine learning. For example, when it is assumed that face recognition, expression recognition, gender classification, pose classification, etc. are performed from face data, each of face recognition, expression recognition, gender classification, and pose classification may correspond to an individual task.

In this specification, multi-task learning means performing learning on a plurality of tasks using one model. In this case, the plurality of tasks may belong to the same domain or may belong to different domains. That is, the multi-task learning may include the concept of multi-domain learning.

In other words, multi-task learning is a learning method that improves performance of all tasks by simultaneously learning related tasks, and as shown in FIG. 1A, is mainly used in fields that simultaneously execute tasks for various purposes, such as autonomous vehicles, smart cities/buildings/homes, and multi-purpose robots.

For example, Advanced Driver Assistance System (ADAS) technologies for autonomous driving, such as smart cruise control (SCC), forward collision warning (FCW), forward collision-avoidance assist (FCA), lane departure warning (LDW), lane keeping assist (LKA), and traffic signal detection and response, have interrelationships between each technology. In this case, simultaneous learning of various tasks for autonomous driving through a single multi-task learning model may improve all performance by reflecting characteristics such as similarities and differences between tasks.

Referring to FIG. 1B, a neural network for multi-task learning may be composed of a generally shared feature extraction layer 3 and output layers 5-1 to 5-n specialized for respective tasks. Looking at a specific learning process, errors 7-1 to 7-n of each task are calculated by feed-forwarding each data sample included in a dataset 1, and a gradient of each task may be calculated from each error 7-1 to 7-n. In addition, a weight (i.e., a learning parameter) of the shared layer 3 may be updated by backpropagating a value obtained by summing the respective gradients of the tasks. An error of a task may mean a difference between prediction of a machine learning model (i.e., a neural network) and an actual result.

In this specification, a neural network is a term encompassing all types of machine learning models designed to imitate neural structures. For example, the neural network may include all types of neural network-based models such as an artificial neural network (ANN) and a convolutional neural network (CNN).

In this specification, an instruction refers to a series of computer readable instructions grouped on the basis of a function, which is a component of a computer program and is executed by a processor.

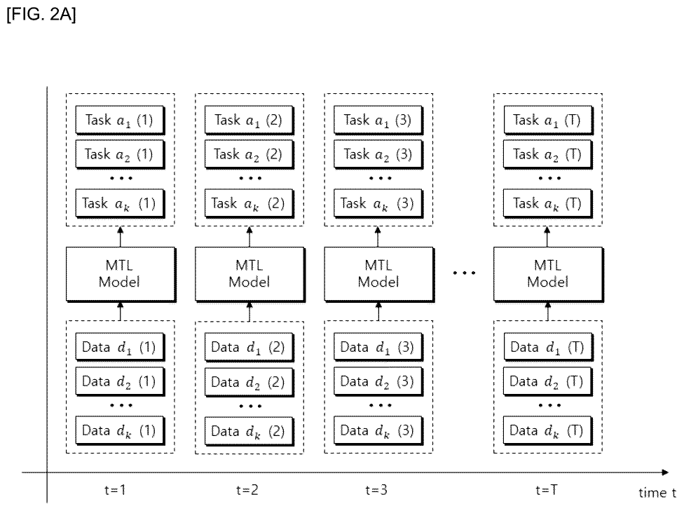

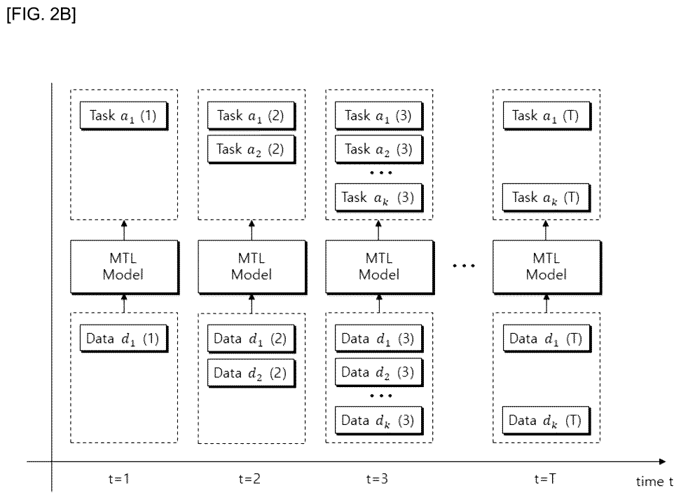

FIG. 2A is a view for explaining synchronous multi-task running.

Referring to FIG. 2A, a synchronous multi-task learning method assumes that tasks and input data required by the tasks are synchronized over time. In other words, in the synchronous multi-task learning method, tasks a₁, a₂, . . . , aₖ (e.g., Classification, Regression, etc.) of a multi-task learning model need to be performed simultaneously at a specific point in time t, and all input data d₁, d₂, . . . , dₖ for executing each task also needs to be received at the specific point in time t.

However, because most tasks in reality are executed asynchronously with each other over time, the synchronous multi-task learning method may have poor performance due to data loss at some point in time.

FIG. 2B is a view for explaining asynchronous multi-task running according to an embodiment.

As described above, most tasks in reality may be executed asynchronously with each other over time as shown in FIG. 2B. For example, tasks executed at a specific point in time may be different, such as Task a₁(1) in t=1 and Tasks a₁(2) and a₂(2) in t=2.

In addition, input data required to execute tasks may also be received asynchronously over time. For example, data received at a specific point in time may be different, such as Data d₁(1) in t=1 and Data d₁(2) and d₂(2) in t=2. For example, SCC, FCW, FCA, LDW, LKA, etc. of an autonomous vehicle are tasks executed in real time, while traffic signal detection and response tasks are executed only when traffic lights exist. In addition, data from sensors such as LIDAR, radar, ultrasonic sensors, and cameras may have different resolutions (e.g., frames per second).

As will be described in detail below, an asynchronous multi-task learning framework according to an embodiment may improve the performance of asynchronous tasks in the presence of time-asynchronous tasks and input data.

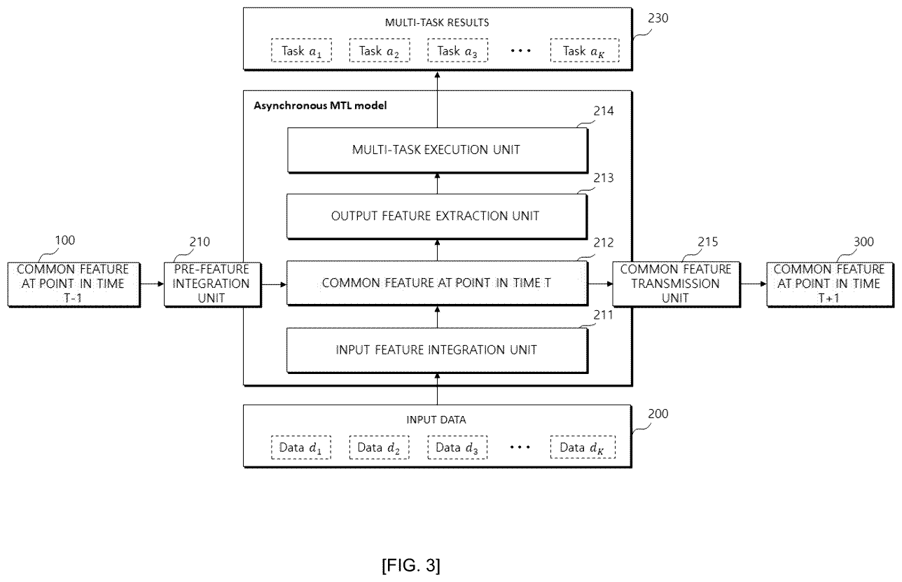

FIG. 3 is a view of a structure of a multi-task learning model according to an embodiment.

Referring to FIG. 3, the multi-task learning model according to an embodiment may include a pre-feature integration unit 210, an input feature integration unit 211, a common feature 212, an output feature extraction unit 213, a multi-task execution unit 214, and a common feature transmission unit 215. However, the elements, shown in FIG. 3, are not essential elements. The multi-task learning model may be implemented by using more or less elements than those shown in FIG. 3. Terms such as “unit”, “er”, “or”, and the like described herein refer to units that perform at least one function or operation, and the units may be implemented as hardware or software or as a combination of hardware and software.

The pre-feature integration unit 210 according to an embodiment may extract a significant feature required at the current point in time t from a common feature 100 at a point in time t−1 and integrate the significant feature into the common feature 212 at the point in time t.

The pre-feature integration unit 210 has a main purpose of integrating common features over time, and integrates common information (common features) between tasks executed in the past to enable task execution even if a specific input is not received at the current point in time t. Hereinafter, a common feature may be used in the same meaning as a common feature vector, and a common feature vector refers to a feature vector of a shared layer.

The pre-feature integration unit 210 may learn a tendency for common feature information according to a past time flow. In this case, as an example, an attention structure that determines which information to focus on from among RNN-based structures such as LSTM and GRU and common characteristic information at a past point in time may be used.

The input feature integration unit 211 according to an embodiment may extract significant features common to multiple tasks from input data 200 received asynchronously and integrate them into the common feature 212 at the point in time t. In this case, all k input data 200 d₁, d₂, . . . , dₖ may be received at the current point in time t, only one specific data may be received, or no data may be received.

The input feature integration unit 211 is to integrate input data into common features, and may use an FNN, CNN or RNN structure that applies non-linear transformation to currently given input data, or an attention structure that intensively extracts features from some input data required at the current point in time t, as an example.

The output feature extraction unit 213 may extract features required for specific multi-task results 230 to be asynchronously executed at the point in time t from the common feature 212 at the point in time t. The main purpose of the output feature extraction unit 213 is to extract features necessary for executing multiple tasks from the common feature 212 at the current point in time t integrated/extracted through a common feature at a past point in time and input data. Nonlinear transformation of common features, an attention structure that determines concentration of common features for each task, or the like may be used as an example.

The multi-task execution unit 214 according to an embodiment may execute an asynchronous multi-task using a feature vector extracted through the output feature extraction unit 213 and output asynchronous multi-task results 230 as a result. At this time, all k multi-task results 230 a₁, a₂, . . . , aₖ may be output at the current point in time t, only one specific task result may be output, or no task result may be output. Examples of an Multi-Task Learning (MTL) task may include classification and regression, and an output method is, for example, one-hot vector, real number, real number vector, etc., but is not limited thereto.

The common feature transmission unit 215 according to an embodiment may transmit the common feature 212 at the current point in time t to a pre-feature integration unit at a point in time t+1 in order to integrate the common feature 212 at the point in time t, which is a result of intermediate processing at the current point in time t, into a common feature 300 at the point in time t+1.

The multi-task learning model according to an embodiment may minimize the loss of information over time by serially integrating data and features of not only a current point in time but also several time points in the past through the pre-feature integration unit 210 and the common feature transmission unit 215, and may improve the execution of multiple tasks through integration of past information even if some input data does not exist at the present point in time.

The pre-feature integration unit 210 and the input feature integration unit 211 according to an embodiment may be the shared feature extraction layer 3 described with reference to FIG. 1B, and the output feature extraction unit 213 and the multi-task execution unit 214 according to an embodiment may be the output layers 5-1 to 5-n specialized for respective tasks described with reference to FIG. 1B.

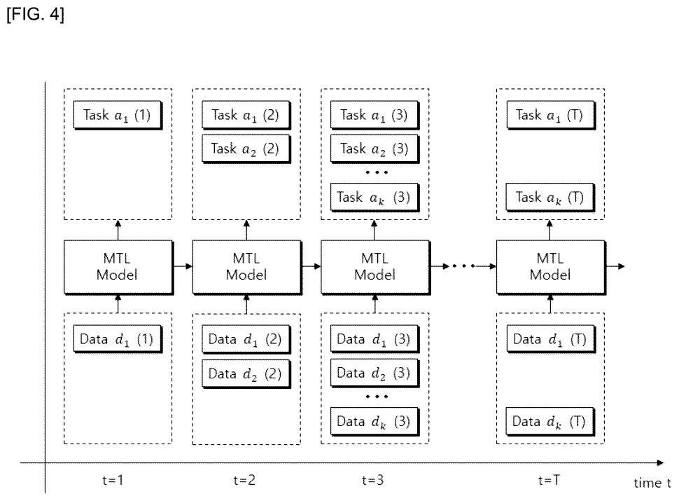

FIG. 4 is a view illustrating an example of an operation method of a multi-task learning model according to an embodiment.

Referring to FIG. 4, unlike existing multi-task learning models, an asynchronous multi-task learning model according to an embodiment may integrate data received asynchronously over time by propagating an intermediate processing result (common feature) at the specific point in time t to intermediate processing at the next point in time t+1.

For example, a₁(1) may be performed by receiving d₁(1) data at t=1, a₁(2) and a₂(2) may be performed by receiving a common feature vector of t=1 and d₁(2) and d₂(2) data at t=2, and a₁(3), a₂(3), . . . , aₖ(3) may be performed by receiving a common feature vector of t=2 and d₁(3), d₂(3), . . . , dₖ(3) data at t=3. Similarly, a₁(T) and aₖ(T) may be performed by receiving a common feature vector of t=(T−1) and d₁(T) and dₖ(T) data at t=T. However, the number and type of data input at each point in time in FIG. 4 is only an example and is not limited thereto, and the number and type of data input at each point in time may vary for each step.

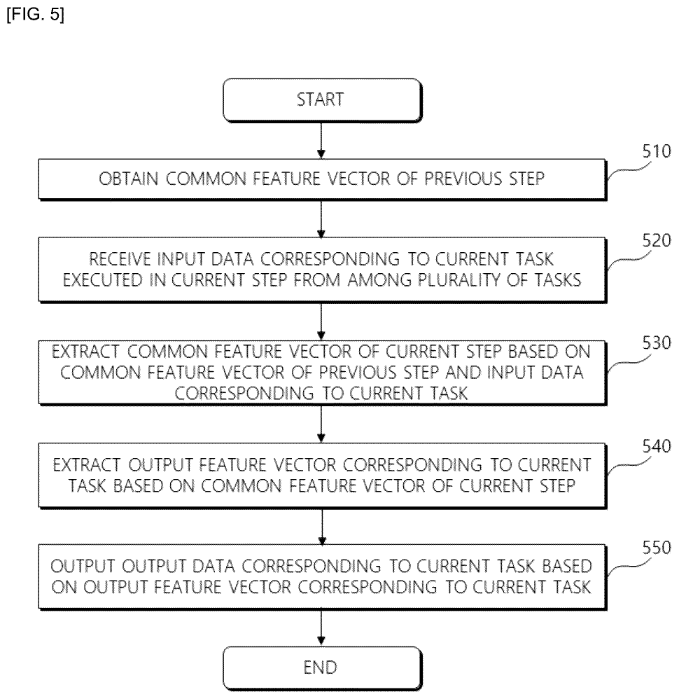

FIG. 5 is a view for explaining an operation method of a multi-task learning model according to an embodiment.

For convenience of description, operations 510 to 550 are described as being performed through the multi-task learning model shown in FIG. 3. However, these operations 510 to 550 could be used with any other suitable electronic device and within any suitable system.

In addition, operations of FIG. 5 may be performed in the illustrated order and manner, but the order of some operations may be changed or some operations may be omitted without departing from the spirit and scope of the illustrated embodiment. A number of operations shown in FIG. 5 may be performed in parallel or concurrently.

In operation 510, the multi-task learning model according to an embodiment may obtain a common feature vector of the previous step. For example, the multi-task learning model may receive a common feature vector at the point in time t−1.

In operation 520, the multi-task learning model according to an embodiment may receive input data corresponding to a current task executed in a current step from among a plurality of tasks. Input data according to an embodiment may be received asynchronously. In other words, the number and type of input data corresponding to the current task may vary for each step. The multi-task learning model may receive various types of inputs (e.g., an FPS resolution of LIDAR, radar, or camera) and execute various types of synchronous/asynchronous tasks (e.g., a real-time task, an event-based task, etc.).

In operation 530, the multi-task learning model according to an embodiment may extract a common feature vector of a current step based on the common feature vector of the previous step and the input data corresponding to the current task. The multi-task learning model may extract a first feature vector based on the common feature vector of the previous step, may extract a second feature vector based on the input data corresponding to the current task, and may extract the common feature vector of the current step based on the first feature vector and the second feature vector.

In more detail, the multi-task learning model may extract a first feature vector including common feature information over time by inputting the common feature vector of the previous step to a first model. The first model may be the pre-feature integration unit 210 described with reference to FIG. 3.

The first model may be an attention layer, and the attention layer may receive the common feature vector of the previous step and extract a first feature vector determined based on attention weight information. The first feature vector may include information about how much weight should be given to common feature information of certain points in time.

In addition, the multi-task learning model may input input data corresponding to a current task to a second model and extract a second feature vector including common feature information of input data corresponding to the current task. The second model may be the input feature integration unit 211 described with reference to FIG. 3. The second model may receive a plurality of input data corresponding to the current task and extract a second feature vector including a significant feature common to multiple tasks from the input data.

The multi-task learning model may generate a common feature vector by weighted summing the first feature vector and the second feature vector. At this time, a weight may be a hyperparameter, and the weight may also be determined through learning.

Alternatively, the first model and the second model may be configured as one integrated model. In this case, the integrated model may be trained to extract common feature information by receiving the common feature vector of the previous step and the input data corresponding to the current task.

Alternatively, both the first model and the second model may be attention layers. In this case, a first feature vector that is an output of the first model may be a first attention weight, and a second feature vector that is an output of the second model may be a second attention weight. At this time, the first attention weight may include common feature information over time, and the second attention weight may include common feature information of input data. The multi-task learning model may determine a weight value according to which information is considered more important from among the common feature information over time and the common feature information of the input data, and may extract a common feature vector through an inner product calculation between the common feature vector of the previous step and the first feature vector (e.g., the first attention weight) and the second feature vector (e.g., the second attention weight), based on the determined weight. In this case, the extracted common feature vector may be an attention value considering both the common feature information over time and the common feature information of the input data.

In operation 540, the multi-task learning model according to an embodiment may extract an output feature vector corresponding to a current task based on a common feature vector of a current step.

In operation 550, the multi-task learning model according to an embodiment may output output data corresponding to the current task based on the output feature vector corresponding to the current task.

The embodiments described above may be implemented by hardware components, software components, and/or any combination thereof. For example, the devices, the methods, and components described in the embodiments may be implemented by using general-purpose computers or special-purpose computers, such as a processor, a controller, an arithmetic logic unit (ALU), a digital signal processor, a microcomputer, a field programmable gate array (FPGA), a programmable logic unit (PLU), a microprocessor, or any other devices which may execute and respond to instructions. A processing apparatus may execute an operating system (OS) and a software application executed in the OS. Also, the processing apparatus may access, store, operate, process, and generate data in response to the execution of software. For convenience of understanding, it may be described that one processing apparatus is used. However, one of ordinary skill in the art will understand that the processing apparatus may include a plurality of processing elements and/or various types of processing elements. For example, the processing apparatus may include a plurality of processors or a processor and a controller. Also, other processing configurations, such as a parallel processor, are also possible.

The software may include computer programs, code, instructions, or any combination thereof, and may construct the processing apparatus for desired operations or may independently or collectively command the processing apparatus. In order to be interpreted by the processing apparatus or to provide commands or data to the processing apparatus, the software and/or data may be permanently or temporarily embodied in any types of machines, components, physical devices, virtual equipment, computer storage mediums, or transmitted signal waves. The software may be distributed over network coupled computer systems so that it may be stored and executed in a distributed fashion. The software and/or data may be recorded in a computer-readable recording medium.

A method according to an embodiment may be implemented as program instructions that can be executed by various computer devices, and recorded on a computer-readable recording medium. The computer-readable recording medium may include program instructions, data files, data structures or a combination thereof. Program instructions recorded on the medium may be particularly designed and structured for embodiments or available to one of ordinary skill in a field of computer software. Examples of the computer-readable recording medium include magnetic media, such as a hard disc, a floppy disc, and magnetic tape; optical media, such as a compact disc-read only memory (CD-ROM) and a digital versatile disc (DVD); magneto-optical media, such as floptical discs; and hardware devices specially configured to store and execute program instructions, such as ROM, random-access memory (RAM), a flash memory, etc. Program instructions may include, for example, high-level language code that can be executed by a computer using an interpreter, as well as machine language code made by a complier.

In concluding the detailed description, those skilled in the art will appreciate that many variations and modifications may be made to the preferred embodiments without substantially departing from the principles of the present invention. Therefore, the disclosed preferred embodiments of the invention are used in a generic and descriptive sense only and not for purposes of limitation.

What is claimed is:

1. An operation method of a multi-task learning model, the operation method comprising:
obtaining a common feature vector of a previous step;
receiving input data corresponding to a current task executed in a current step from among a plurality of tasks;
extracting a common feature vector of the current step based on the common feature vector of the previous step and the input data corresponding to the current task;
extracting an output feature vector corresponding to the current task based on the common feature vector of the current step; and
outputting output data corresponding to the current task based on the output feature vector corresponding to the current task.

2. The operation method of claim 1, wherein the extracting of the common feature vector of the current step comprises:
extracting a first feature vector based on the common feature vector of the previous step;
extracting a second feature vector based on the input data corresponding to the current task; and
extracting the common feature vector of the current step based on the first feature vector and the second feature vector.

3. The operation method of claim 2, wherein the extracting of the first feature vector comprises:
extracting the first feature vector including common feature information over time by inputting the common feature vector of the previous step to a first model, and
the extracting of the second feature vector comprises:
inputting the input data corresponding to the current task to a second model and extracting the second feature vector including common feature information of the input data corresponding to the current task.

4. The operation method of claim 2, wherein the extracting of the common feature vector of the current step comprises:
determining a weight between the first feature vector and the second feature vector; and
extracting the common feature vector through an inner product calculation between the common feature vector of the previous step and the first feature vector and the second feature vector, based on the determined weight.

5. The operation method of claim 1, wherein the number and type of input data corresponding to the current task vary for each step.
